(19) United States
(12) Patent Application Publication
(10) Pub. No.: US 2026/0308012 A1
(43) Pub. Date: Oct. 8, 2026

(54) METAL HYDROXIDE PARTICLES AND POSITIVE ELECTRODE ACTIVE MATERIAL

(71) Applicant: TOYOTA JIDOSHA KABUSHIKI KAISHA, Toyota-shi (JP)

(72) Inventors: Ryosuke OHSAWA, Okazaki-shi (JP); Momoko PROCTER, Soto-shi (JP)

(73) Assignee: TOYOTA JIDOSHA KABUSHIKI KAISHA, Toyota-shi (JP)

(21) Appl. No.: 19/459,304

(22) Filed: Jan. 26, 2026

(30) Foreign Application Priority Data
Apr. 7, 2025 (JP) 2025-063083

(51) Int. Cl. C01G 53/05; H01M 4/02; H01M 4/525

(52) U.S. Cl. CPC C01G 53/05; H01M 4/525; C01P 2004/45; C01P 2004/84; C01P 2006/40; H01M 2004/028

(57) ABSTRACT

In the present disclosure, the metal hydroxide particles used as a precursor of a positive electrode active material are secondary particles in which a plurality of primary particles are aggregated, the primary particles contain a transition metal element, and when the metal hydroxide particles are viewed in cross section, the metal hydroxide particles have at least a first layer X, a second layer X, a third layer X, a fourth layer X, and a fifth layer X from the outermost surface toward the center, the second layer X is a layer denser than the first layer X, the third layer X is a layer coarser than the second layer X, the fourth layer X is a layer denser than the third layer X, and the fifth layer X is a layer coarser than the fourth layer X.

### CROSS-REFERENCE TO RELATED APPLICATION

This application claims priority to Japanese Patent Application No. 2025-063083 filed on Apr. 7, 2025. The disclosure of the above-identified application, including the specification, drawings, and claims, is incorporated by reference herein in its entirety.

### BACKGROUND

### 1. Technical Field

The present disclosure relates to metal hydroxide particles and a positive electrode active material.

### 2. Description of Related Art

In recent years, batteries have been eagerly developed. For example, in the automotive industry, lithium ion batteries for use in battery electric vehicles (BEVs), plug-in hybrid electric vehicles (PHEVs), or hybrid electric vehicles (HEVs) have been developed. Various studies have been made on positive electrode active materials of the batteries and precursors (metal hydroxides) thereof.

For example, Japanese Unexamined Patent Application Publication No. 2022-166095 (JP 2022-166095 A) discloses a transition metal-containing composite hydroxide composed of secondary particles formed by aggregation of plate-like primary particles, the transition metal-containing composite hydroxide including at least one low-density layer formed by aggregation of fine primary particles having a smaller particle size than the plate-like primary particles in the range of the secondary particles of up to 30% with respect to the particle size of the secondary particles from the surface of the secondary particles, in which the average ratio of the thickness of the at least one low-density layer to the particle size of the secondary particles is in the range of 3% to 15%.

Japanese Unexamined Patent Application Publication No. 2018-45759 (JP 2018-45759 A) discloses a positive electrode active material for a lithium secondary battery, the positive electrode active material being a lithium composite metal oxide including secondary particles obtained by aggregation of primary particles, and having voids inside the secondary particles, in which the number of the voids per 1 μm² is 0.3 or more and 15 or less in the cross section of the secondary particles. Furthermore, JP 2018-45759 A discloses that in the cross section of the secondary particles, a particle center portion and a particle surface portion each have the center of gravity of at least one or more voids, and the porosity of the particle surface portion is 0.75% or more and 50% or less.

### SUMMARY

From the viewpoint of improving the battery performance, it is desired to reduce the cycle resistance increase rate. The present disclosure has been made in view of the above circumstances, and has a main object to provide a precursor (metal hydroxide particles) capable of obtaining a positive electrode active material having a low cycle resistance increase rate.

Metal hydroxide particles that are used as a precursor of a positive electrode active material, in which:
the metal hydroxide particles are secondary particles obtained by aggregation of a plurality of primary particles;
the primary particles contain a transition metal element;
when the metal hydroxide particles are viewed in cross section, the metal hydroxide particles include at least a first layer X, a second layer X, a third layer X, a fourth layer X, and a fifth layer X from an outermost surface toward a center;
the second layer X is a layer that is denser than the first layer X;
the third layer X is a layer that is coarser than the second layer X;
the fourth layer X is a layer that is denser than the third layer X; and
the fifth layer X is a layer that is coarser than the fourth layer X.

Metal hydroxide particles that are used as a precursor of a positive electrode active material, in which:
the metal hydroxide particles are secondary particles obtained by aggregation of a plurality of primary particles;
the primary particles contain a transition metal element;
when the metal hydroxide particles are viewed in cross section, the metal hydroxide particles include at least a first layer Y, a second layer Y, a third layer Y, a fourth layer Y, and a fifth layer Y from an outermost surface toward a center;
the second layer Y is a layer that is coarser than the first layer Y;
the third layer Y is a layer that is denser than the second layer Y;
the fourth layer Y is a layer that is coarser than the third layer Y; and
the fifth layer Y is a layer that is denser than the fourth layer Y.

The metal hydroxide particles according to the above, in which the primary particles contain at least one of an Ni element, a Co element, and an Mn element as the transition metal element.

The metal hydroxide particles according to the above, in which: the primary particles contain the Ni element as the transition metal element; and a ratio of the Ni element in an entirety of the transition metal element is 50 mol % or more.

A positive electrode active material that is a fired product of the metal hydroxide particles according to the above.

In the present disclosure, it is possible to provide a precursor (metal hydroxide particles) capable of obtaining a positive electrode active material having a low cycle resistance increase rate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating metal hydroxide particles in the present disclosure;

FIG. 2 is a schematic cross-sectional view illustrating metal hydroxide particles according to the present disclosure;

FIG. 3 is a schematic cross-sectional view illustrating a battery in the present disclosure.

### DETAILED DESCRIPTION OF EMBODIMENTS

Hereinafter, the metal hydroxide particles in the present disclosure will be described in detail. Note that the drawings shown below are examples, and the size of each part and the shape of each part may be exaggerated for ease of understanding.

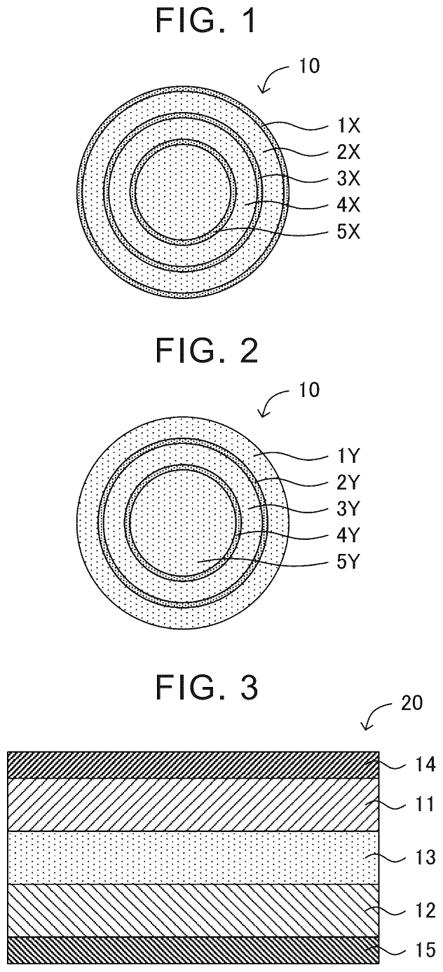

The metal hydroxide particles in the present disclosure are used as a precursor of a positive electrode active material. As shown in FIGS. 1 and 2, the metal hydroxide particles 10 are secondary particles in which a plurality of primary particles (primary particles containing a transition metal element) are aggregated.

As shown in FIG. 1, when the metal hydroxide particles 10 are viewed in cross section, the metal hydroxide particles 10 may have at least a first layer X (1X), a second layer X (2X), a third layer X (3X), a fourth layer X (4X), and a fifth layer X (5X) from the outermost surface toward the center. Each of the first layer X (1X) to the fifth layer X (5X) is composed of a plurality of primary particles (primary particles including a transition metal element).

As shown in FIG. 1, the second layer X (2X) is a layer denser than the first layer X (1X), the third layer X (3X) is a layer coarser than the second layer X (2X), the fourth layer X (4X) is a layer denser than the third layer X (3X), and the fifth layer X (5X) is a layer coarser than the fourth layer X (4X). The roughness of each layer can be confirmed, for example, by observing the cross section of the metal hydroxide particles with a SEM as described later. In this case, the sparse layer is observed relatively dark and the dense layer is observed relatively bright. Further, as shown in FIG. 2, the relationship of the coarseness of each layer may be opposite to the relationship of the coarseness shown in FIG. 1.

According to the present disclosure, the presence of a plurality of relatively dense layers makes it possible to obtain a positive electrode active material having a low cycle resistance increase rate (metal hydroxide particles). When the metal hydroxide particles have a plurality of relatively dense layers, the positive electrode active material, which is a fired body of the metal hydroxide particles, usually also has a plurality of relatively dense layers. When the positive electrode active material includes a plurality of relatively dense layers, it is presumed that film growth due to side reactions between the positive electrode active material and the electrolytic solution can be suppressed and the cycle resistance increase rate becomes low.

Further, according to the present disclosure, the presence of a plurality of relatively sparse layers makes it possible to obtain a positive electrode active material having a low resistance (metal hydroxide particles). When the metal hydroxide particles have a plurality of relatively sparse layers, the positive electrode active material, which is a fired body of the metal hydroxide particles, usually also has a plurality of relatively sparse layers. When the positive electrode active material includes a plurality of relatively sparse layers, the primary particles constituting the positive electrode active material easily come into contact with the electrolytic solution, and the resistance can be reduced.

### Layer 1 to Layer 5

As shown in FIG. 1, when the metal hydroxide particles 10 are viewed in cross section, the metal hydroxide particles 10 may have at least a first layer X (1X), a second layer X (2X), a third layer X (3X), a fourth layer X (4X), and a fifth layer X (5X) from the outermost surface toward the center. Each of the first layer X (1X) to the fifth layer X (5X) is composed of a plurality of primary particles (primary particles including a transition metal element). In the cross section of the metal hydroxide particles 10, the first layer X (1X) to the fifth layer X (5X) are, for example, ring-shaped layers.

As shown in FIG. 1, the second layer X (2X) is a layer denser than the first layer X (1X), the third layer X (3X) is a layer coarser than the second layer X (2X), the fourth layer X (4X) is a layer denser than the third layer X (3X), and the fifth layer X (5X) is a layer coarser than the fourth layer X (4X). As shown in FIG. 1, the metal hydroxide particles 10 may have a layer denser than the fifth layer X (5X) inside the fifth layer X (5X).

The fact that the second layer X is a denser layer than the first layer X can be confirmed by observing the cross section of the metal hydroxide particles with a scanning electron microscope (SEM) and visually observing the shades (contrasts) of the second layer X and the first layer X in the obtained SEM images. As described above, the sparse layer is observed relatively dark and the dense layer is observed relatively bright. As SEM image, an image captured under the condition that the conditions of the second layer X and the first layer X are most easily distinguishable is adopted. Alternatively, SEM images may be 8-bit transformed by image-processing software (e.g., image-J) to obtain contrast-differences between the second layer X and the first layer X. The contrast difference is preferably 14 or more. In the above description, the coarse-dense relationship in the second layer X and the first layer X has been described, but the same applies to the coarse-dense relationship in other adjacent layers (for example, the third layer X and the second layer X).

As shown in FIG. 2, when the metal hydroxide particles 10 are viewed in cross section, the metal hydroxide particles 10 may have at least a first layer Y (1Y), a second layer Y (2Y), a third layer Y (3Y), a fourth layer Y (4Y), and a fifth layer Y (5Y) from the outermost surface toward the center. Each of the first layer Y (1Y) to the fifth layer Y (5Y) is composed of a plurality of primary particles (primary particles including a transition metal element). In the cross section of the metal hydroxide particles 10, the first layer Y (1Y) to the fourth layer Y (4Y) are each a ring-shaped layer. As shown in FIG. 2, the fifth layer Y (5Y) may have a circular shape.

As shown in FIG. 2, the second layer Y (2Y) is a layer sparser than the first layer Y (1Y), the third layer Y (3Y) is a layer denser than the second layer Y (2Y), the fourth layer Y (4Y) is a layer sparser than the third layer Y (3Y), and the fifth layer Y (5Y) is a layer denser than the fourth layer Y (4Y). Further, although not particularly illustrated, another layer (for example, a layer sparser than the fifth layer Y) may be disposed inside the fifth layer Y. In this case, the fifth layer Y is usually an annular layer.

### Primary Particle

The primary particles in the present disclosure are hydroxides containing transition metal elements. Examples of the transition metal element include an Ni element, a Co element, and an Mn element. The primary particles may contain at least one of an Ni element, a Co element, and an Mn element, and may contain two or more kinds of transition metal elements.

The primary particles preferably contain at least an Ni element as the transition metal element. The ratio of Ni element to all of the transition metal element is, for example, 30 mol % or more, may be 50 mol %, may be 60 mol % or more, may be 70 mol % or more, may be 80 mol % or more. On the other hand, the ratio of Ni element is usually 100 mol % or less, may be 98 mol % or less, may be 95 mol % or less, may be 90 mol % or less, may be 85 mol % or less.

The primary particles may contain a Co element as a transition metal element, or may not contain a Co element. The ratio of the Co element to all of the transition metal elements is, for example, not less than 0 mol %, may be not less than 3 mol %, may be not less than 5 mol %, and may be not less than 10 mol %. On the other hand, the ratio of the Co element is, for example, 30 mol % or less.

The primary particles may contain an Mn element as a transition metal element, or may not contain an Mn element. The ratio of Mn element to all of the transition metal elements is, for example, not less than 0 mol %, may be not less than 3 mol %, may be not less than 5 mol %, and may be not less than 10 mol %. On the other hand, the ratio of Mn element is, for example, not more than 30 mol %.

The primary particles may contain elements other than the transition metal element, the O element, and the H element. Examples of the other elements include metal elements belonging to Groups 12 to 14 in the periodic table. Examples of the metallic elements belonging to Groups 12 to 14 include Zn, Al, Si, Ga, Ge, In, Sn.

### Metal Hydroxide Particles

The metal hydroxide particles in the present disclosure are secondary particles in which the plurality of primary particles described above are aggregated. The number of primary particles constituting the secondary particles is, for example, 100 or more. On the other hand, the number of primary particles constituting the secondary particles is not particularly limited, but is, for example, 10000 or less.

The particle size of the secondary particles is, for example, 10 μm or more and 50 μm or less. Further, it is preferable that the secondary particles have a void (a space in which the primary particles do not exist) inside. The porosity of the secondary particles is, for example, 10% or more and 40% or less. The porosity of the secondary particles can be measured, for example, by performing software-based image analysis on the cross-sectional SEM image.

A method for producing the metal hydroxide particles is not particularly limited, and examples thereof include a crystallization method as described in Examples described below. The first layer X to the fifth layer X in the present disclosure can be adjusted, for example, by changing conditions in the crystallization method. Specifically, it is preferable to adjust the concentration of the raw material aqueous solution containing the transition metal element and the reaction temperature. For example, when the concentration of the raw material aqueous solution and the reaction temperature are increased, a relatively dense layer can be formed, and when the concentration of the raw material aqueous solution and the reaction temperature are decreased, a relatively sparse layer can be formed. By repeating these operations, relatively dense layers and relatively sparse layers can be alternately formed.

### Positive Electrode Active Material

The positive electrode active material in the present disclosure is a calcined product of the metal hydroxide particles described above. The positive electrode active material is usually metal oxide particles. Further, the present disclosure can also provide the following positive electrode active material.

### Positive Electrode Active Material Used in Battery

The positive electrode active material is a secondary particle in which a plurality of primary particles are aggregated,

The primary particles contain a Li element, a transition metal element, and an O element,

When the secondary particles are viewed in cross section, the secondary particles have at least a first layer x, a second layer x, a third layer x, a fourth layer x, and a fifth layer x from the outermost surface toward the center,

The second layer x is a layer denser than the first layer x,

The third layer x is a layer coarser than the second layer x,

The fourth layer x is a layer denser than the third layer x,

The fifth layer x is coarser than the fourth layer x.

### Positive Electrode Active Material Used in Battery

The positive electrode active material is a secondary particle in which a plurality of primary particles are aggregated,

The primary particles contain a Li element, a transition metal element, and an O element,

When viewed cross-section of the secondary particles, the secondary particles, toward the center from the outermost surface, the first layer y, the second layer y, the third layer y, has at least a fourth layer y and the fifth layer y,

The second layer y is a layer coarser than the first layer y,

The third layer y is a layer denser than the second layer y,

The fourth layer y is a layer coarser than the third layer y,

The fifth layer y is a layer denser than the fourth layer y.

The composition of the primary particles in the positive electrode active material is not particularly limited, and the composition represented by the general formula LiₓNiₐCo_{b}Mn_{c}O_{y} (0.1≤x≤1.5, 0.5≤a≤1.0, 0≤b≤0.3, 0≤c≤0.3, a+b+c=1.0, 1.5≤y≤2.1), for example, may be mentioned. Al may be used instead of Mn in the above formulae.

The production process of the positive electrode active material is not particularly limited, but it can be produced, for example, by adding a Li source (e.g., LiOH, Li₂CO₃) to the above-described metal hydroxide particles and firing them, as described in Examples below. The positive electrode active material is used in a battery. The battery will be described later.

### Battery

In the present disclosure, a battery including a positive electrode active material layer containing the above-described positive electrode active material can also be provided. FIG. 3 is a schematic cross-sectional view illustrating a battery in the present disclosure. The battery 20 illustrated in FIG. 3 includes a positive electrode active material layer 11, a negative electrode active material layer 12, an electrolyte layer 13 disposed between the positive electrode active material layer 11 and the negative electrode active material layer 12, a positive electrode current collector 14 that collects electrons of the positive electrode active material layer 11, and a negative electrode current collector 15 that collects electrons of the negative electrode active material layer 12. In the battery 10, the positive electrode active material layer 11 contains the above-described positive electrode active material.

### A Cathode Active Material Layer Including

The positive electrode active material layer contains the above-described positive electrode active material. Since the positive electrode active material is the same as the content described in the “positive electrode active material”, the description thereof will be omitted. The proportion of the positive electrode active material in the positive electrode active material layer is, for example, 20 mass % or more and 95 mass % or less.

The positive electrode active material layer may optionally contain at least one of a conductive material, a binder, and an electrolyte. Examples of the conductive material include a carbon-based conductive material. Examples of the carbon-based conductive material include particulate materials such as acetylene black (AB) and Ketjen black (KB), and fibrous materials such as gas phase carbon fibers (VGCF), carbon nanotubes (CNT), and carbon nanofibers (CNF). Examples of the binder include rubber-based binders such as styrene-butadiene rubber (SBR) and butadiene rubber (BR), polycarboxylic acid-based binders such as carboxymethyl cellulose, and fluoride-based binders such as polyvinylidene fluoride (PVdF). As the electrolyte, there can be mentioned an electrolyte described in “electrolyte layer”.

### Negative Electrode Active Material Layer

The negative electrode active material layer contains at least a negative electrode active material. Examples of the negative electrode active material include a carbon-based active material, a Li active material, a Si active material, and an oxide-based active material.

Examples of the carbon-based active material include graphite, soft carbon, and hard carbon. The graphite may be natural graphite or artificial graphite. Examples of Li active material include Li, Li alloys. Examples of Li alloy include Li—Si alloys. Examples of Si active material include Si, SiC complex active materials, Si alloys, and Si oxides. Examples of SiC complex active material include an active material in which Si or Si is supported on a carbon-support. Examples of the oxide-based active material include lithium titanate such as Li₄Ti₅O₁₂.

The negative electrode active material layer may contain at least one of a conductive material, a binder, and an electrolyte. The conductive material, the binder, and the electrolyte are the same as those described in the “positive electrode active material layer”.

### Electrolyte Layer

The electrolyte layer is a layer disposed between the positive electrode active material layer and the negative electrode active material layer, and contains at least an electrolyte. The electrolyte is, for example, a liquid electrolyte (electrolytic solution).

Examples of the electrolytic solution include a non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆ and organic lithium salts such as LiCF₃SO₃, LiN(SO₂CF₃)₂, LiN(SO₂C₂F₅)₂, LiC(SO₂CF₃)₃.

Examples of the non-aqueous solvent include carbonate-based solvents such as ethylene carbonate (EC), propylene carbonate (PC), butylene carbonate (BC), dimethyl carbonate (DMC), diethyl carbonate (DEC), and ethyl methyl carbonate (EMC).

The electrolyte layer may include a separator that impregnates the above-described electrolyte solution. The material of the separator may be a conventionally known material.

### Battery

The battery preferably includes a positive electrode current collector that collects the positive electrode active material layer and a negative electrode current collector that collects the negative electrode active layer. Examples of the positive electrode current collector include SUS, aluminum, nickel, iron, titanium, and carbon. On the other hand, examples of the negative electrode current collector include SUS, copper, nickel, and carbon. Further, the battery in the present disclosure may have an exterior body that houses a power generation element (a positive electrode active material layer, an electrolyte layer, and a negative electrode active material layer). Examples of the exterior body include a case-type exterior body and a laminate-type exterior body.

The battery in the present disclosure is typically a lithium-ion battery. The battery in the present disclosure may be a primary battery or a secondary battery, but is preferably a secondary battery. This is because the battery can be repeatedly charged and discharged, and is useful, for example, as an in-vehicle battery. Applications of lithium-ion batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Further, the battery may be used as a power source for a moving object (for example, a railway, a ship, or an aircraft) other than the vehicle, or may be used as a power source for an electric product such as an information processing apparatus.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Comparative Example 1

### Preparation of Precursor Particles

Precursor particles (metal hydroxide particles) of the positive electrode active material were prepared in the following manner.

### Preparation of Raw Aqueous Solution

First, as a raw material, NiSO₄, CoSO₄ and MnSO₄ were prepared, and these were dissolved in ion-exchanged water to prepare an aqueous raw material solution. The ratio of Ni and Mn in the raw aqueous solution was Ni:Co:Mn=8:1:1 in molar ratio. The concentration of the raw material aqueous solution (ratio of all raw materials to the raw material aqueous solution) was 30% by mass.

### Crystallization

A fixed amount of NH₃ aqueous solution was placed in the reaction vessel, and the inside of the reaction vessel was nitrogen-substituted while stirring with a stirrer. An aqueous NaOH solution was added to the reaction vessel, pH was kept alkaline (pH=11), and an aqueous raw material solution and an aqueous NH₃ solution were added dropwise at a reaction temperature of 40° C. for 3 hours while being controlled at a constant temperature. NH₃ concentration was adjusted to the drip rate of NH₃ aqueous solution so as to be constantly 15 g/L. As a result, a crystallized material (precipitate) was obtained.

### Washing and Drying

The precipitate was collected by filtration and washed with ion-exchanged water. Thereafter, drying was performed at 120° C. for 16 hours to obtain precursor particles.

### Preparation of Positive Electrode Active Material

A mortar was used to mix the precursor grains and Li source (LiOH). The ratio (molar ratio) of Li to the sum of the transition metal elements contained in the precursor-particles was 1.1. The resulting mixture was calcined in a muffle furnace at 900° C. for 10 hours. The obtained fired body was crushed using a jet mill to adjust the particle size, thereby obtaining a positive electrode active material.

### Preparation of Batteries

A battery was prepared using the obtained positive electrode active material. Specifically, a positive electrode mixture paste containing a positive electrode active material, a conductive material (acetylene black) and a binder (polyvinylidene fluoride) in a mass ratio of positive electrode active material:conductive material:binder=88:10:2 was applied to the surface of a metal foil serving as a positive electrode current collector using a film applicator with a film thickness adjusting function (manufactured by All Grid Co., Ltd.). Thereafter, the mixture was dried in a dryer at 80° C. for 5 minutes to obtain a positive electrode having a positive electrode current collector and a positive electrode active material layer.

Next, a negative electrode mixture paste including a negative electrode active material (natural graphite) and a binder (SBR and CMC) was applied to the surface of a metallic foil serving as a negative electrode current collector using a film applicator with a film thickness adjusting function (manufactured by All Grid Co., Ltd.). Thereafter, the negative electrode was dried in a dryer at 80° C. for 5 minutes to obtain a negative electrode having a negative electrode current collector and a negative electrode active material layer. Next, LiPF₆ solutions of concentrated 1M were prepared as electrolyte solutions. As the solvent of the electrolyte solution, a mixed solvent obtained by mixing ethylene carbonate (EC), dimethyl carbonate (DMC), and ethyl methyl carbonate (EMC) in a volume ratio of EC:DMC:EMC of 3:4:3 was used. A wound cylindrical battery was obtained using the positive electrode, the negative electrode, and the electrolytic solution.

### Example 1

The raw material aqueous solution A was prepared in the same manner as in Comparative Example 1 except that the concentration of the raw material aqueous solution was changed to 20% by mass. The raw material aqueous solution B was prepared in the same manner as in Comparative Example 1 except that the concentration of the raw material aqueous solution was changed to 40% by mass. Next, a fixed amount of an aqueous solution of NH₃ was placed in the reaction vessel, and the inside of the reaction vessel was nitrogen-substituted while being stirred with a stirrer. An aqueous NaOH solution was added to the reactor, pH was kept alkaline (pH=11), and an aqueous raw material solution (raw material aqueous solution A or raw material aqueous solution B) and an aqueous NH₃ solution were added dropwise while being controlled to a constant temperature. NH₃ concentration was adjusted to the drip rate of NH₃ aqueous solution so as to be constantly 15 g/L.

Dropping conditions were dropped for 30 minutes at a reaction temperature of 25° C. using the raw material aqueous solution A (first dropping treatment), then dropped for 30 minutes at a reaction temperature of 55° C. using the raw material aqueous solution B (second dropping treatment), then the first dropping treatment and the second dropping treatment was repeated twice (total time: 3 hours). As a result, a crystallized material (precipitate) was obtained. Precursor particles, positive electrode active material, and battery were obtained in the same manner as in Comparative Example 1 except that the obtained precipitate was used.

### Example 2

Dropping conditions were dropped for 22.5 minutes at a reaction temperature of 25° C. using the raw material aqueous solution A (first dropping treatment), then dropped for 22.5 minutes at a reaction temperature of 55° C. using the raw material aqueous solution B (second dropping treatment), then the first dropping treatment and the second dropping treatment was repeated 3 times (total time: 3 hours) except that to obtain a crystallized product (precipitate) in the same manner as in Example 1. Precursor particles, positive electrode active material, and battery were obtained in the same manner as in Comparative Example 1 except that the obtained precipitate was used.

### Example 3

Dropping conditions were dropped for 18 minutes at a reaction temperature of 25° C. using the raw material aqueous solution A (first dropping treatment), then dropped for 18 minutes at a reaction temperature of 25° C. using the raw material aqueous solution B (second dropping treatment), then the first dropping treatment and the second dropping treatment was repeated 4 times (total time: 3 hours) except that to obtain a crystallized product (precipitate) in the same manner as in Example 1. Precursor particles, positive electrode active material, and battery were obtained in the same manner as in Comparative Example 1 except that the obtained precipitate was used.

### Evaluation

### Cross-Sectional Observation

The cross sections of the precursor particles (metal hydroxide particles) obtained in Examples 1 to 3 and Comparative Example 1 were observed by a scanning electron microscope (SEM). When the obtained SEM images were visually observed, it was confirmed in Examples 1 to 3 that sparse layers and dense layers were alternately arranged, such as an annual ring. On the other hand, in Comparative Example 1, the sparse layer and the dense layer were confirmed one by one. Further, SEM images were 8-bit transformed by image-J to obtain contrast-differences between adjacent layers. The results are shown in Table 1.

TABLE 1

| | Ratio | | | Number of layers | | Contrast- |
|---|---|---|---|---|---|---|
| | Ni | Co | Mn | Sparse | Dense | difference |
| Comparative | 0.8 | 0.1 | 0.1 | 1 | 1 | 14 |
| Example 1 | | | | | | |
| Example 1 | 0.8 | 0.1 | 0.1 | 3 | 3 | 15 |
| Example 2 | 0.8 | 0.1 | 0.1 | 4 | 4 | 17 |
| Example 3 | 0.8 | 0.1 | 0.1 | 5 | 5 | 18 |

### Cycle Resistance Increase Rate

Using the batteries obtained in Examples 1 to 3 and Comparative Example 1, the cycle resistance increase rate was measured. Specifically, the resistance (IV resistance) before and after the cycling test was measured. In the cycle test, 100 cycles were performed under the conditions of a voltage range: 3.0 V to 4.3 V, a C rate: 0.3C, a mode: CC charge/discharge, and a temperature of 50° C., and the cycle resistivity increasing rate was determined based on the following equation.

Cycle Resistance Increase (%)=(Resistance after cycle test)/Initial Resistance×100

The test results are shown in Table 2.

TABLE 2

| | Ratio | | | | |
|---|---|---|---|---|---|
| | Li | Ni | Co | Mn | Cycle resistance increase rate (%) |
| Comparative | 1.1 | 0.8 | 0.1 | 0.1 | 171 |
| Example 1 | | | | | |
| Example 1 | 1.1 | 0.8 | 0.1 | 0.1 | 132 |
| Example 2 | 1.1 | 0.8 | 0.1 | 0.1 | 124 |
| Example 3 | 1.1 | 0.8 | 0.1 | 0.1 | 118 |

As shown in Table 2, in Examples 1 to 3, it was confirmed that the cycle resistance increase rate was reduced as compared with Comparative Example 1. This is presumably because the presence of the dense layer suppressed film growth due to side reactions between the positive electrode active material and the electrolytic solution. Further, as described in Examples 1 to 3, it was confirmed that as the number of dense layers increases, the cycle resistance increase rate decreases.

What is claimed is:

1. Metal hydroxide particles that are used as a precursor of a positive electrode active material, wherein:
the metal hydroxide particles are secondary particles obtained by aggregation of a plurality of primary particles;
the primary particles contain a transition metal element;
when the metal hydroxide particles are viewed in cross section, the metal hydroxide particles include at least a first layer X, a second layer X, a third layer X, a fourth layer X, and a fifth layer X from an outermost surface toward a center;
the second layer X is a layer that is denser than the first layer X;
the third layer X is a layer that is coarser than the second layer X;
the fourth layer X is a layer that is denser than the third layer X; and
the fifth layer X is a layer that is coarser than the fourth layer X.

2. Metal hydroxide particles that are used as a precursor of a positive electrode active material, wherein:
the metal hydroxide particles are secondary particles obtained by aggregation of a plurality of primary particles;
the primary particles contain a transition metal element;
when the metal hydroxide particles are viewed in cross section, the metal hydroxide particles include at least a first layer Y, a second layer Y, a third layer Y, a fourth layer Y, and a fifth layer Y from an outermost surface toward a center;
the second layer Y is a layer that is coarser than the first layer Y;
the third layer Y is a layer that is denser than the second layer Y;
the fourth layer Y is a layer that is coarser than the third layer Y; and
the fifth layer Y is a layer that is denser than the fourth layer Y.

3. The metal hydroxide particles according to claim 1, wherein the primary particles contain at least one of an Ni element, a Co element, and an Mn element as the transition metal element.

4. The metal hydroxide particles according to claim 3, wherein:
the primary particles contain the Ni element as the transition metal element; and
a ratio of the Ni element in an entirety of the transition metal element is 50 mol % or more.

5. A positive electrode active material that is a fired product of the metal hydroxide particles according to claim 1.
